(19) United States
(12) Patent Application Publication
(10) Pub. No.: US 2015/0079484 A1
(43) Pub. Date: Mar. 19, 2015

(54) ELECTROLYTE ADDITIVES IN SUPPORT OF FIVE VOLT LITHIUM ION CHEMISTRY

(71) Applicant: U.S. Army Research Laboratory, Attn: RDRL-LOC-I, Adelphi, MD (US)

(72) Inventors: Arthur von Wald Cresce, Silver Spring, MD (US); Kang Conrad Xu, North Potomac, MD (US)

(73) Assignee: U.S. Government as represented by the Secretary of the Army, Adelphi, MD (US)

(21) Appl. No.: 14/028,559

(22) Filed: Sep. 17, 2013

(51) Int. Cl. H01M 10/0567; H01M 10/0525

(52) U.S. Cl. CPC H01M 10/0567; H01M 10/0525
USPC 429/338; 429/200; 429/342; 429/337; 429/341; 429/336; 429/340; 429/339

(57) ABSTRACT

The present disclosure relates to additives for electrolytes and preparation of aluminum-based, silicon-based, and bismuth-based additive compounds that can be used as additives or solutes in electrolytes and test results in various electrochemical devices. The inclusion of these aluminum, silicon, and bismuth compounds in electrolyte systems can enable rechargeable chemistries at high voltages that are otherwise unsuitable with current electrolyte technologies. These compounds are so chosen because of their beneficial effect on the interphasial chemistries formed at high potentials, such as 5.0 V class cathodes for Li-ion chemistries. The application of these compounds goes beyond Li-ion battery technology and covers any electrochemical device that employs electrolytes for the benefit of high energy density resultant from high operating voltages.

### BACKGROUND

### Field of Use

The present disclosure relates to electrolytes having enhanced electrochemical stability, particularly for use supporting Li-ion chemistries that occur near or above 5.0 V, and even more particularly to electrolyte additives that enhance electrochemical cell performance.

Li ion chemistry is established upon reversible intercalation/de-intercalation of Li ion into/from host compounds. Operational voltage of such an electrochemical device is determined by the chemical natures of anode and cathode, where Li ion is accommodated or released at low potentials in the anode, and at high potentials in the cathode. The reversibility of the cell chemistry and the resultant energy density are limited by the stability of the electrolyte to withstand the reductive and oxidative potentials of these electrodes. Currently, electrolytes use organic carbonates, such as ethylene carbonate or ethyl methyl carbonate, and are used in the majority of modem rechargeable Li-ion batteries. Organic carbonate solvents oxidatively decompose at about 4.5V (vs. Li reference), which sets an upper limit on the candidate cathode chemistry. Despite the fact that 5V Li-ion chemistry has already been made available from such cathodes as the olivine-structured LiCoPO₄ (approx. 5.1V) and spinel structured LiNi_{0.5}Mn_{1.5}O₄ (approx. 4.7V), their advantages as cathode materials cannot be realized due to the lack of an electrolyte that can withstand repeated cycles at high voltage operation.

Under high voltages, the electrolyte in the electrochemical cell decomposes and is unstable. During operation, a relative thin film or layer forms at the surface boundary of the cathode and the anode. Ion passivation occurs through both the liquid electrolyte and the semi-solid film layer. Over time, this layer deteriorates or grows as the liquid portion decomposes. Increased voltage causes both the solid and liquid phase of the electrolyte to decompose at a rapid rate causing fewer cycles achievable by a given electrochemical cell.

Selecting or designing a solvent system that was able to resist oxidative decomposition beyond 5V has been investigated. Asymmetrical sulfones and cyclic sulfones were developed and tested against the moderately-high voltage cathode LiMn₂O₄, which was published in two papers: K. Xu, et al, J. Electrochem. Soc., 1998, Vol. 145, L70; J. Electrochem. Soc., 2002, Vol. 149, A920 both of which are incorporated herein by reference in their entirety. While the sulfones proved to be more resistant to oxidative decomposition than carbonates, they had intrinsic shortcomings that made their use impractical and difficult. The high viscosity of sulfones (tetramethylene sulfone and ethyl methyl sulfone) led to poor electrode active material utilization and slow Li-ion kinetics, and without exception the sulfones were unable to form a protective passivation layer on graphitic anodes.

Improvements were made on mitigating the oxidizing nature on the cathode surfaces using surface coating approaches, and various metal oxides or phosphates were shown to be effective in elongating the service life of the carbonate-based electrolytes (J. Liu, et al, Chem. Mater, 2009, Vol. 21, 1695), the complete disclosure of which is incorporated herein by reference. But these coating approaches have their own intrinsic shortcomings as well. They not only add additional cost to the manufacturing of the cathode materials, but also induce further interphasial resistance to the Li ion migration at electrolyte/cathode junction. Moreover, overall coverage of cathode particle surface with those inert coatings will inevitably decrease the energy density of the device.

More recently, improvements were reported in the arena of electrolyte additives and published on a class of high-voltage electrolyte additives based on fluorinated alkyl phosphates (A. V. Cresce, K. Xu, J. Electrochem. Soc., 2011, Vol. 158(3), A337), the complete disclosure of which is incorporated herein by reference. This paper is related to U.S. Patent Application Publication Number 2012/0009485, the subject matter of which is incorporated by reference in its entirety. The 2012/0009485 application is related to the use of phosphate additives to extend the range of carbonate electrolytes up past 4.7V. Rather than modifying the organic carbonate solvents used in Li-ion batteries, these phosphate additives can be used to form a more protective passivation layer on the highly oxidizing cathode surface.

It is therefore of significant interest to find a variety of technologies that can effectively enable 5.0 V class cathodes applied in Li ion batteries, without the aforementioned shortcomings.

It is further of significant interest to find a technology that can effectively enable the 5.0 V class cathode to be applied in Li ion batteries, while there is no major negative impact on the original electrolyte and cathode materials. Such negative impact have been exhibited in the prior art, and include but are not limited to, the failure of electrolyte to form desired interphasial chemistry on a graphitic anode, the slowed Li ion kinetics and difficult electrode wetting due to high electrolyte viscosity, the increased electrolyte/cathode interphasial impedance, additional processing cost of material manufacturing, and sacrificed cathode energy density, etc.

It is therefore still of significant interest to identify such electrolytes that can stably support reversible Li ion chemistry, without those shortcomings exhibited previously.

It is of further interest to identify such compounds that, once incorporated as an electrolyte component, can assist in forming a protective layer on the surface of the 5.0 V class cathodes.

It is still yet a further interest to the battery industry to identify such compounds that could serve the aforementioned purposes either as electrolyte solvent, co-solvent, solute, or both molecular and ionic additives.

### SUMMARY

The present disclosure relates to an electrochemical cell including: a negative electrode; a positive electrode; an electrolyte material adapted to allow for ion passivation between the negative and positive electrodes; and an additive dispersed in the electrolyte material. The additive includes a compound having at least one fluoro-alkyl functional group and a backbone structure selected from the group consisting of organoaluminum, organosilicon, and organobismuth. The electrochemical cell can include a Lithium ion source for Lithium ion passivation between the negative and positive electrodes.

In an example, the additive can include at least one compound having a structure selected from the group (1)-(10) below:

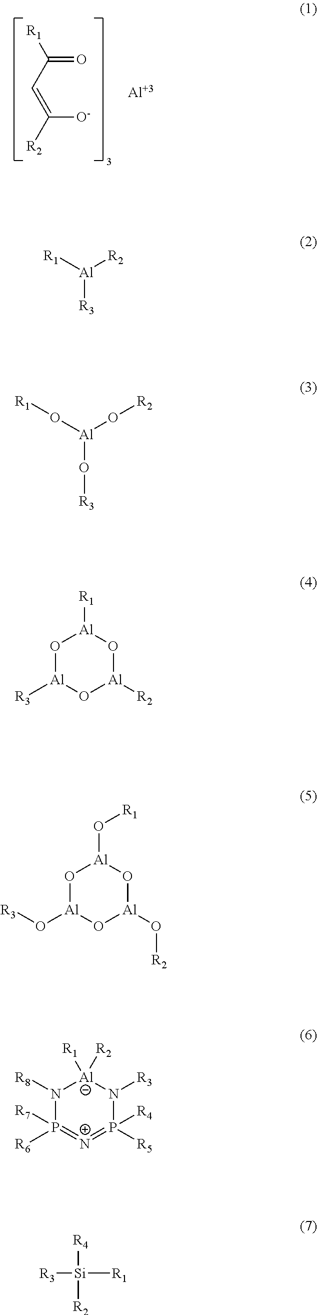

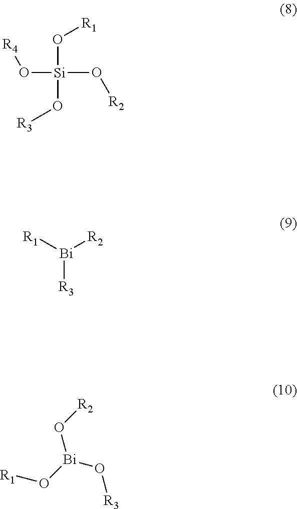

wherein: R1, R2, R3, R4, R5, R6, R7, and R8 designate substituents which are identical or different from each other and selected from the groups (i)-(iv): (i) hydrogen, hydroxyl, or halogen; (ii) hydroxide salts with metal ions of various valences including at least one of Li+, Na+, ½Mg2+, ⅓Al3+, and combinations thereof; (iii) normal or branched alkyls with carbon number from 1 through 30, with or without unsaturation; (iv) normal or branched halogenated alkyls with carbon number ranges from 1 to 30, with or without unsaturation, wherein their halogenation degree varies from monohalogenation to perhalogenation; and (iv) partially halogenated or perhalogenated normal or branched alkyls with a carbon number from 1 through 30, where the halogen substituents are identical or different and selected from the group of F, Cl, Br, I, and mixtures thereof.

In a further example, the additive includes at least one compound having a structure selected from the group (11)-(21) below:

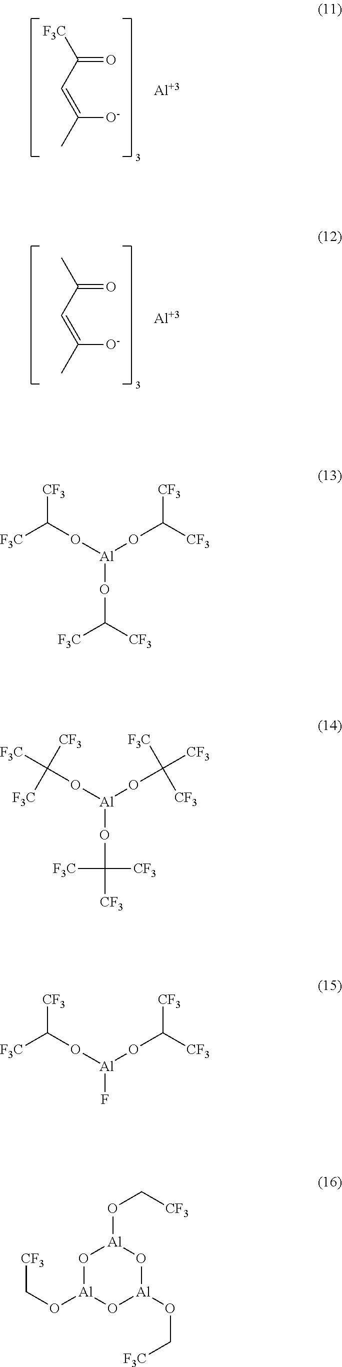

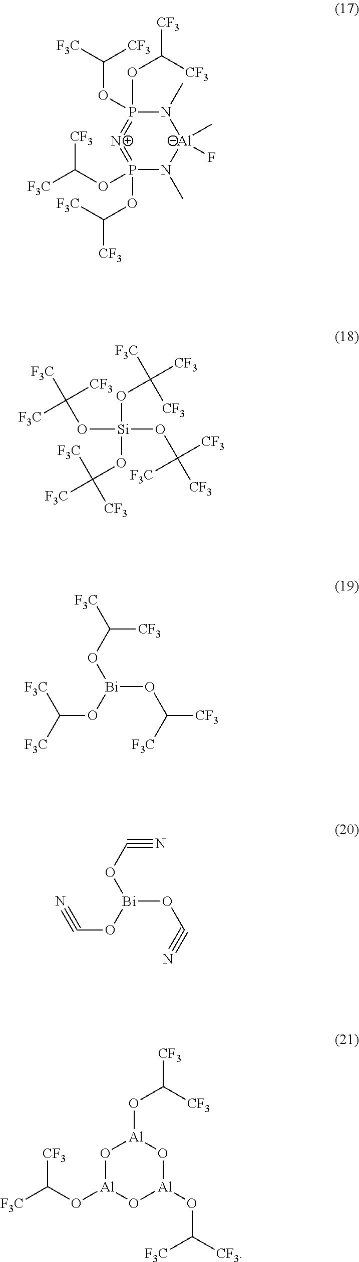

The electrolyte material can include a co-solvent, solute or additive including one or more compounds having the structure from the group (1)-(10), further having solubility of at least 1 ppm in a nonaqueous electrolyte solvent. The electrolyte material can further include a non-aqueous organic solvent present in liquid form in the absence of an electric charge.

In a further example, the electrochemical cell can further include a separator miscible in the electrolyte material, wherein the separator is selected from the group consisting of a porous polyolefin separator and a gellable polymer film. The separator can be miscible with non-aqueous electrolytes with a solubility of at least 1.0 ppm. The electrolyte material can include members from the group consisting of: aqueous solvents, non-aqueous solvents, alkali salts, ammonium salts, phosphonium salts, and mixtures thereof.

The additive can be provided in sufficient amount to passivate the cathode surface and reduce decomposition occurring greater than 4.2 V vs. Li. In yet a further example, the additive is provided in sufficient amount to passivate the cathode surface and reduce decomposition occurring at voltages of greater than 5.0 V vs. Li.

The electrochemical cell can include an electrolyte material that includes an electrolyte composition comprising one or more of: aqueous or non-aqueous solvents, alkali, ammonium, phosphonium or other metal salts, and molecular or ionic additives. In an example, the electrolyte material can include non-aqueous solvents or solvent mixtures including at least one of: (i) cyclic or acyclic carbonates and carboxylic esters selected from the group consisting: EC, PC, VC, DMC, DEC, EMC, FEC, γ-butyrolactone, methyl butyrate, ethyl butyrate, and mixtures thereof; (ii) cyclic or acyclic ethers selected from diethylether, dimethyl ethoxglycol, tetrahydrofuran, and mixtures thereof, (iii) cyclic or acyclic organic sulfones and sulfites selected from tetramethylene sulfone, ethylene sulfite, ethylmethyl sulfone, and mixtures thereof; and (iv) cyclic or acyclic nitriles selected from acetonitrile, ethoxypropionitrile; and derivatives and mixtures thereof.

In an example, the electrolyte material includes salt or salt mixture selected from the group consisting of: lithium hexafluorophosphate (LiPF₆), lithium hexafluoroarsenate (LiAsF₆), lithium tetrafluoroborate (LiBF₄), lithium perfluoroalkylfluorophosphate (LiP(CnF₂ₙ₊₁)ₓF₆₋ₓ, where 0≦n≦10, 0≦x≦6), lithium perfluoroalkylfluoroborate (LiB(CnF₂ₙ₊₁)ₓF₄₋ₓ, where 0≦n≦10, 0≦x≦4), lithium bis(trifluoromethanesulfonyl)imide (LiIm), lithium bis(perfluoroethanesulfonyl)imide (LiBeti), lithium bis(oxalato)borate (LiBOB), and lithium (difuorooxalato)borate (LiBF₂C₂O₄), and mixtures thereof.

In yet a further example, the additive can be present in a concentration range from 0.1 ppm to 10% with respect to the total solvent weight. Still further, the additive can be present in a concentration range from 0.1% to 1% compared to total volume of the electrolyte material. The negative electrode can include an intercalation material having a lattice structure to accommodate any guest ions or molecules. The intercalation material can be selected from the group consisting of carbonaceous materials with various degree of graphitization, lithiated metal oxides, chalcogenides, and mixtures thereof.

The positive electrode can include an active material selected from the group consisting of transition metal oxides, metalphosphates, chalcogenides, carbonaceous materials with various degree of graphitization, and mixtures thereof. The positive and negative electrodes can include materials of either high surface area for double-layer capacitance, or high pseudo-capacitance, or mixture of both.

The present disclosure further provides for an electrolyte for use in an electrochemical cell having a positive and negative electrode, the electrolyte including: an electrolyte material; and an additive dispersed in the electrolyte material. The additive includes a compound having at least one fluoro-alkyl functional group and a backbone structure selected from the group consisting of organoaluminum, organosilicon, and organobismuth.

### BRIEF DESCRIPTION OF THE DRAWINGS

FIG. 1 illustrates a schematic example of an electrochemical cell according to the present disclosure.

FIG. 2 illustrates an example comparison of voltage profiles between baseline, state-of-the-art electrolyte (left) and 0.3% additive of (#9 from Table 2, aluminum trifluoroacetylacetonate) in base electrolyte (right) on LiNi_{0.5}Mn_{1.5}O₄ surface. For graphic clarity only cycles between the initial and the 100^{th} were shown with an increment of 10 cycles.

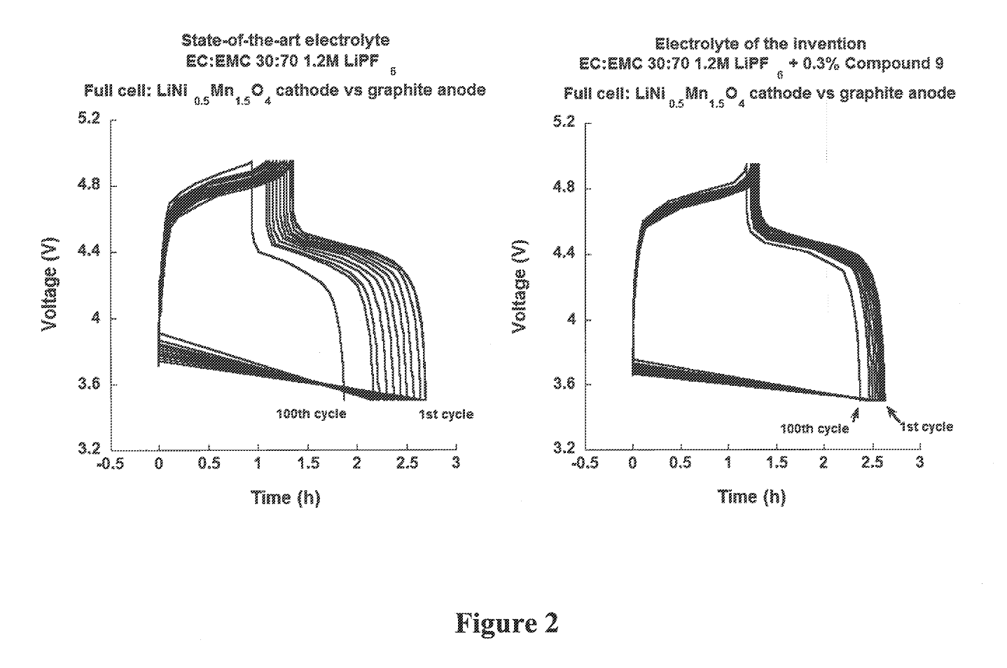

FIG. 3 illustrates an example comparison of differential capacity plotted vs. voltage for base electrolyte and 0.3% aluminum trifluoroacetylacetonate base electrolyte at the 10^{th} (left) and 100^{th} (right) cycles.

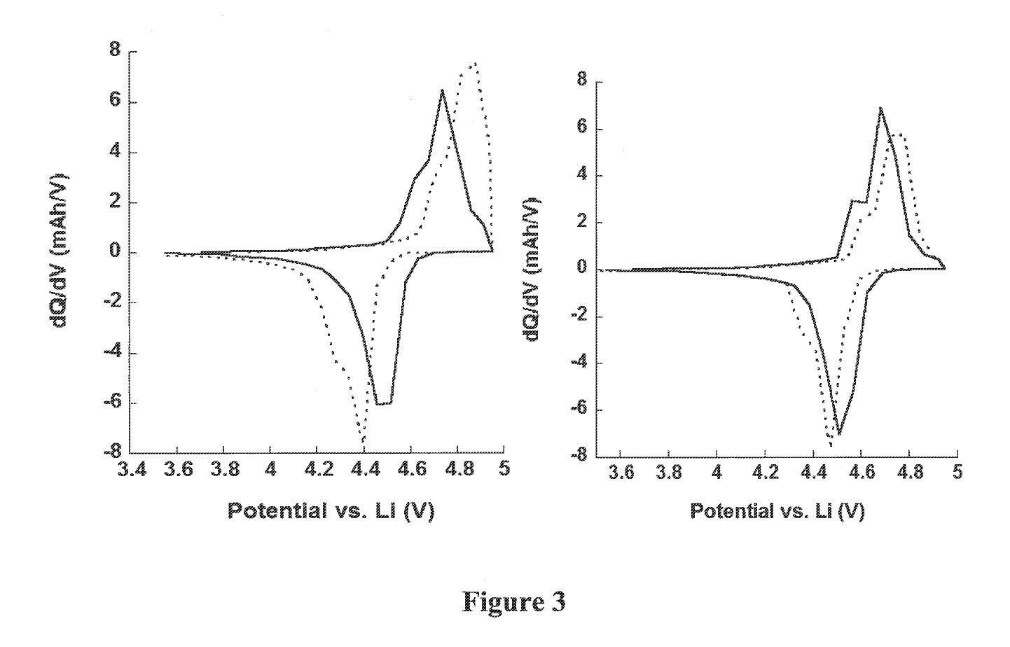

FIG. 4 illustrates an example comparison of capacity retention (right) of LiNi_{0.5}Mn_{1.5}O₄/graphite full cells cycled in base electrolyte, 0.3% aluminum acetylacetonate, and 0.3% tris(1,1,1,3,3,3-hexafluoro isopropyl)aluminate base electrolyte under galvanostatic conditions.

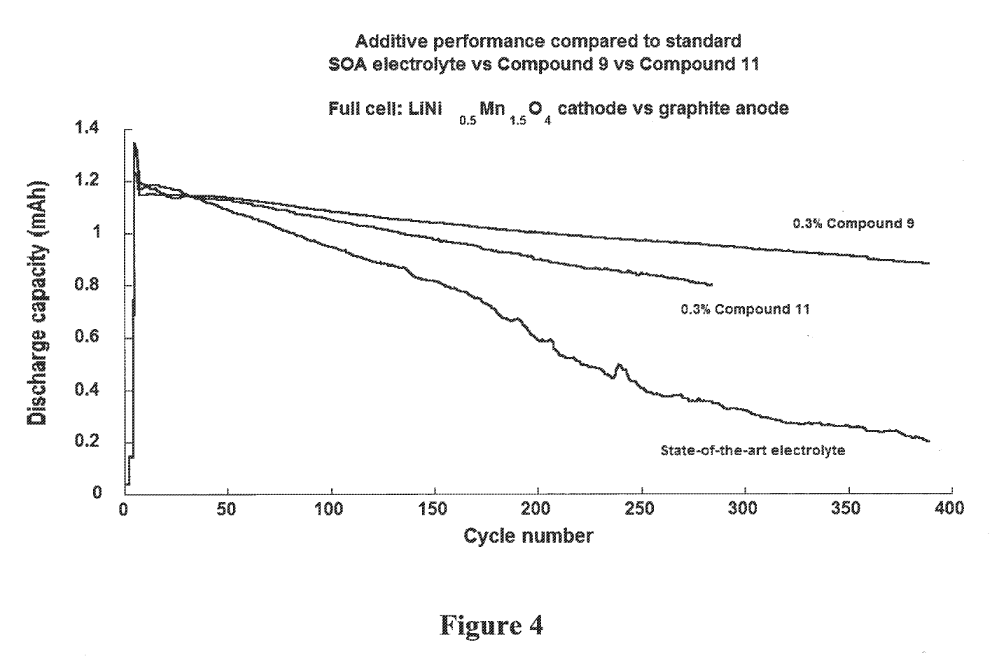

### DETAILED DESCRIPTION

The present disclosure relates to an electrolyte for use in electrochemical cells.

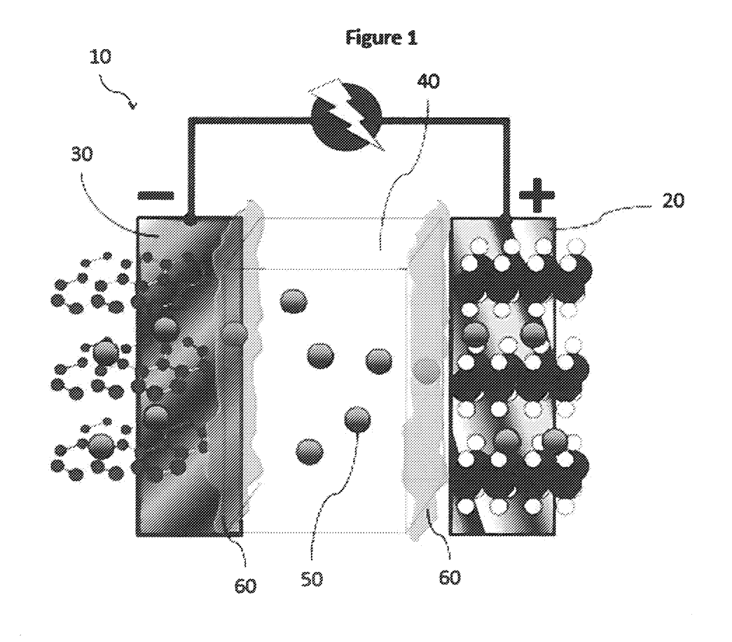

Referring to FIG. 1, an electrochemical cell 10 according to the present disclosure includes a pair of oppositely charged electrodes, a positive electrode 20 (cathode), and a negative electrode 30(anode). An electrolyte material 40 is provided in intimate contact with both electrodes 20 and 30 allowing for ion 50 passivation between the electrodes. The electrolyte material 40 is typically a liquid. The present disclosure provides for an electrolyte material that further includes an additive. It is within the scope of the present disclosure to refer to the additive as having or containing at least one fluorinated compound. The fluorinated compound is believed to react with reactive sites on the cathode and anode surfaces forming a protective layer. This protective layer prevents decomposition at higher voltages while still allowing desired cycling of the electrochemical cell.

The interphase of the electrode and electrolyte can be referred to as an SEI (“Solid Electrolyte Interphase”) layer 60. When a voltage is applied, a film or layer 60 of solid electrolyte material is formed on the surface of the electrode. The inclusion of the additive forms a protective film at the SEI 60 thereby preventing or reducing decomposition at higher operational voltages.

### DEFINITIONS

Before describing the present disclosure in further detail, it is helpful to define the terminologies used in this disclosure so that it helps to understand the spirit of the present disclosure. It is to be understood that the definition herein is for the purpose of describing particular embodiments only, and is not intended to be limiting.

In the present disclosure, the term “organic” refers to a structure that contains hydrocarbon moieties.

In the present disclosure, the term “inorganic” refers to a structure that contains no hydrocarbon moieties.

In the present disclosure, the term “alkyl” refers to a hydrocarbon structure, with or without unsaturations, or their perhalogenated or partially halogenated derivatives.

The term “solvent” refers to molecular components of the electrolyte.

The term “solute” or “salt” refers to ionic components of the electrolyte, which will dissociate into cationic and anionic species upon dissolution in the solvents or mixture of co-solvents.

The term “co-solvents” refers to molecular components of the electrolyte whose concentrations are at least 10% by weight.

Furthermore, the term “additives” are the molecular components of the electrolyte whose concentrations are at most or lower than 10% by weight.

The term “molecular” refers to compounds that cannot be dissociated into any ionic species in non-aqueous electrolyte solvents.

The term “ionic” refers to compounds that can be dissociated into a cation species that bears positive charge and an anion species that bears equal but negative charge in non-aqueous electrolyte solvents.

It is desirable to develop electrochemical cells that can reversibly store and release electricity at voltages above 4.5 V.

Particularly, it is desirable to develop electrochemical cells that can reversibly store and release electricity at voltages in the neighborhood of or above 5.0 V.

Still more particularly, it is desirable to develop the aforementioned electrochemical cells, which include, but are not limited to, rechargeable batteries that are based on Li ion chemistry, or electrochemical double-layer capacitors that comprise high surface area electrodes.

Yet still more particularly, it is desirable to develop the aforementioned electrochemical cells based on Li ion chemistry, which comprise of 5.0 V class cathode materials such as, but are not limited to, spinel metal oxide LiNi_{0.5}Mn_{1.5}O₄ or olivine phosphate LiCoPO₄, and materials of other chemical natures.

Even yet still more particularly, it is desirable to develop the aforementioned electrochemical cells based on electrochemical double layer capacitance, which include high surface area materials as electrodes, such as, but are not limited to, graphite, activated carbon, aligned or random carbon nanotubes, various aerogels and materials of other chemical natures.

Further yet, it is desirable to formulate electrolyte materials and compositions that would enable the aforementioned electrochemical cells.

Even further yet, it is desirable to identify and develop compounds that, once incorporated into electrolytes either as electrolyte solvent, co-solvent, solute or molecular and ionic additives, would assist in stabilizing the electrolyte against oxidative decompositions, and reduce negatively impacting the properties and performances of the electrochemical cells.

It is another objective of the present disclosure to develop the electrolyte compositions utilizing such compounds either as solute or molecular and ionic additives. Electrolytes so formulated will have a wider electrochemical stability window, and are capable of supporting electrochemical processes occurring at high potentials without persistent degrading.

It is still another objective of the present disclosure to assemble electrochemical cells utilizing such electrolyte solutions. Examples of electrochemical cells include, but are not limited to, rechargeable batteries or electrochemical double-layer capacitors that have been described above. The cells thus developed should deliver superior performances as compared with the state-of-the-art technologies in terms of the energy density and energy quality.

These and additional objectives of the disclosure are accomplished by adopting one or more compounds either as solvent, co-solvent, solute, or molecular and ionic additives in the non-aqueous electrolytes.

More particularly, these and additional objectives of the disclosure are accomplished by adopting one or more compounds in the non-aqueous electrolytes, which are soluble in the non-aqueous, organic electrolyte solvents to certain concentrations.

Still more particularly, these compounds, upon dissolution in the non-aqueous electrolytes, will form desirable interphasial chemistry on cathode surfaces. The compounds, upon dissolution in the non-aqueous electrolytes, will either form desirable interphasial chemistry on anode surfaces, or will not negatively impact the other electrolyte components to form desirable interphasial chemistry on anode surfaces. With the electrolyte solutions including these compounds either as solvent, co-solvent, solute, or molecular and ionic additives in the non-aqueous electrolytes, all the said objectives can be achieved.

Even still more particularly, the present disclosure relates to the compounds that can be incorporated into electrolytes as electrolyte co-solvents, electrolyte additives, or electrolyte solutes, the result of such incorporation being that the electrolytes can support the reversible Li ion intercalation/de-intercalation chemistry at potentials above 4.5 V. Still more particularly, the present disclosure relates to compounds that can be incorporated into the electrolyte as electrolyte co-solvents, electrolyte additives, or electrolyte solutes, which, upon the initial charging of the cathode, decompose sacrificially to form a passivation film. This passivation film prevents sustaining decomposition of electrolyte components but does not hinder the reversible Li ion intercalation/de-intercalation chemistry at potentials above 4.5 V.

In an example the present disclosure is intended to enable the use of high voltage cathode materials in rechargeable lithium-ion batteries. Current state-of-the-art lithium-ion batteries operate with a maximum voltage of 4.2 V, in part limited by the electrochemical stability of the electrolyte itself. A lithium-ion battery operating at voltage higher than 4.2 V will have a higher energy density and will deliver higher-quality direct electric current. State-of-the-art electrolytes, comprised primarily of organic carbonate esters, decompose at electrode potentials below 4.5 V against the cathode surface, causing persistent and parasitic capacity fading accompanied with increasing internal cell impedance.

In a further example, high voltage cathodes and cathode materials include, but are not limited to, transition-metal oxides with spinel lattice structures, metal fluorides, metal pyrophosphates, and metal phosphates with olivine structures.

In a further example, the compounds used in the electrolytes of the present disclosure go beyond the battery application and could benefit any electrochemical devices that operate at high potentials. The presence of the compounds in the electrolyte can stabilize the highly oxidizing surface of the positive electrode and hence enable new chemistry that is otherwise not achieved with the current state-of-the-art electrolyte technology. Such electrochemical devices include, but are not limited to, rechargeable and non-rechargeable batteries, double layer capacitors, pseudo-capacitors, electrolytic cells, fuel cells, etc.

In an example, batteries or electrochemical devices include a pair of electrodes an electrolyte material. These electrochemical devices can include, but are not limited to: an anode, a cathode, and an electrolyte adapted to allow for passing of Li-ion between the two electrodes. An anode can include materials selected from the group consisting of lithium or other alkali metals, alloys of lithium or other alkaline metals, intercalation hosts such as layered structured materials of graphitic, carbonaceous, oxides or other chemical natures, non-intercalating hosts of high surface area or high pseudo-capacitance, and the like. A cathode can include materials selected from the group consisting of an intercalation host based on metal oxides, phosphates, fluorides or other chemical natures, or non-intercalating hosts of high surface area or high pseudo-capacitance, and the like.

The present disclosure provides for additive compounds in an electrolyte. In an example, the additive compound includes at least one fluorinated alkyl compound. In a further example, the additive compound constructed on a basis of molecular or ionic compounds whose skeleton structures are shown in structures 1 through 10 in Table 1 below:

TABLE 1
Structure of Novel Compounds in the Present Invention

| | |
|---|---|
| 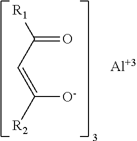 | (1) |
| 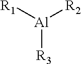 | (2) |
| 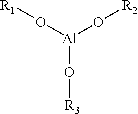 | (3) |
| 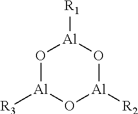 | (4) |
| 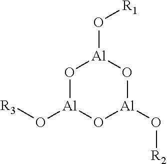 | (5) |
| 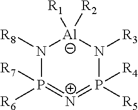 | (6) |
| 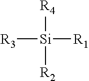 | (7) |
| 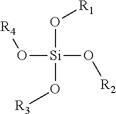 | (8) |
| 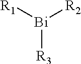 | (9) |
| 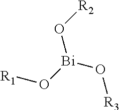 | (10) |

where:

R₁, R₂, R₃, R₄, R₅, R₆, R₇, and R₈ designate substituents,

which can be identical or different from each other,

which can be hydrogen, hydroxyl, or halogen;

which can be hydroxide salts with metal ions of various valences, examples of which include, but are not limited to, Li+, Na+, ½Mg₂+, ⅓A₁₃+, Etc;

which can be normal or branched alkyls with carbon number from 1 through 30, with or without unsaturation;

which can be halogenated normal or branched alkyls with carbon number from 1 through 30, with or without unsaturation;

which can be partially halogenated or perhalogenated normal or branched alkyls with carbon number from 1 through 30, with or without unsaturation;

which can be partially halogenated or perhalogenated normal or branched alkyls with carbon number from 1 through 30, where the halogen substituents can be identical or different selected from F, Cl, Br or 1, or mixture of all halogens.

Examples of R₁, R₂, R₃, R₄, R₅, R₆, R₇, and R8 include, but are not limited to, trifluoromethyl, trichloromethyl, 1,1,1-trifluoroethyl, perfluoroethyl, perfluoro-iso-propyl, 1,1,1,3,3,3,-hexafluoropropyl, perfluoro-tert-butyl, isocyanate, isothiocyanate, etc. As a way to illustrate, Table 2 lists compounds 11-21 that are included in the compound families as described in Table 1:

TABLE 2
Example of Novel Compounds covered in Table 1

| | |
|---|---|
| 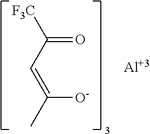 | (11) |
| 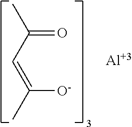 | (12) |
| 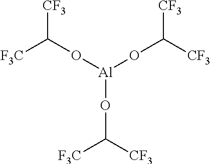 | (13) |
| 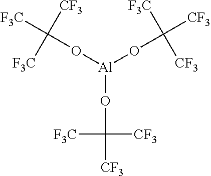 | (14) |
| 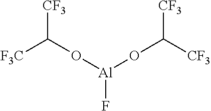 | (15) |
| 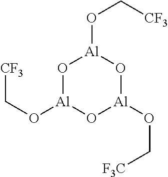 | (16) |
| 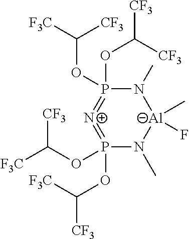 | (17) |
| 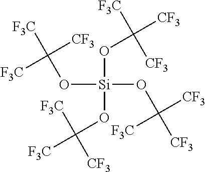 [SMILES: FC(F)(F)C(O[Si](OC(C(F)(F)F)(C(F)(F)F)C(F)(F)F)(OC(C(F)(F)F)(C(F)(F)F)C(F)(F)F)OC(C(F)(F)F)(C(F)(F)F)C(F)(F)F)(C(F)(F)F)C(F)(F)F] | (18) |
| 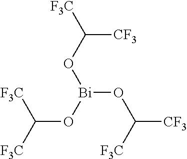 | (19) |
| 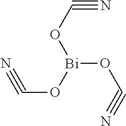 | (20) |
| 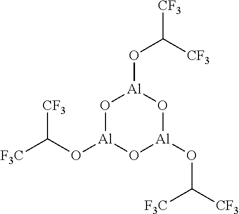 | (21) |

In an example, the additive compounds as listed in Table 1 and 2 above can be dissolved in typical non-aqueous electrolyte solvent or mixture of solvents. The compounds can serve in the electrolyte either as additives at concentrations below 10% by weight, or as salts at concentrations as high as 3.0M. The non-aqueous electrolyte solvents can include, but are not limited to, organic carbonate esters such as ethylene carbonate (EC), propylene carbonate (PC), dimethylcarbonate (DMC), ethylmethylcarbonate (EMC), diethylcarbonate (DEC), 1-(trifluoromethyl)ethylene carbonate (CF₃-EC), etc; or organic acid esters such as alkyl carboxylates, lactones, et cetera; and inorganic acid esters such as alkyl sulfonates, alkyl sulfurates, alkyl phosphonates, alkyl nitrates, and etc.; or dialkyl ethers that are either symmetrical or unsymmetrical, or alkyl nitriles.

The above-mentioned typical non-aqueous electrolytes also can include electrolyte solutes that are based on a cation and an anion. The cation selections include but are not limited to, alkali metal salts such as lithium (Li), sodium (Na), potassium (K), etc., or alkali earth metal salts such as beryllium (Be), magnesium (Mg), calcium Ca), etc., or tetraalkylammonium or phosphonium (R₄N, R₄P); whereas the anion selections include but are not limited to (PF₆), hexafluoroarsenate (AsF₆), tetrafluoroborate (BF₄), perfluoroalkylfluorophosphate (PFₓRF₍₆₋ₓ₎)), perfluoroalkylfluoroborate (BFₓRF₍₄₋ₓ₎), bis(trifluoromethanesulfonyl)imide ((CF₃SO₂)₂N), bis(perfluoroethanesulfonyl)imide ((CF₃CF₂SO₂)₂N), bis(oxalato)borate ((C₂O₄)₂B), (difluorooxalato)borate (C₂O₄F₂B). The salts are selected by combining these cation and anions.

The present disclosure provides for electrolyte additive compounds that include at least one fluorine in the structure. In an example, the compound can be selected from the group consisting of: aluminum trifluoroacetylacetonate (compound 11 in Table 2), tris(1,1,1,3,3,3-hexafluoro isopropyl)aluminate (compound 13 in Table 2), tris(perfluoro-t-butyl)aluminate (compound 14 in Table 2), tetrakis(perfluoro-t-butyl)silicate (compound 18 in Table 2); tris(1,1,1,3,3,3-hexafluoro isopropyl)bismate (compound 19 in Table 2), and tris(1,1,1,3,3,3-hexafluoro isopropyl)cyclotrioxoaluminin (compound 21 in Table 2), or the like.

In yet further example, the present disclosure provides for fabricating electrochemical devices that are filled with the electrolyte solution formulated as discussed above. These devices include, but are not limited to, (1) lithium batteries with lithium metal cells as anode, and various transition metal oxides, phosphates and fluorides as cathode; (2) Li ion batteries with carbonaceous materials such as graphite, carbon nanotubes, graphene, or graphene oxide as anode, or non-carbonaceous such as titania or other Li+ intercalating hosts as anode, and various transition metal oxides, phosphates and fluorides as cathode; (3) electrochemical double-layer capacitors with both carbonaceous and non-carbonaceous electrodes of high surface area or high pseudo-capacitance; and (4) dual intercalation cells in which both cation and anion intercalate simultaneously into lattices of anode and cathode materials of either carbonaceous or non-carbonaceous natures, respectively.

The above cells are assembled according to the procedures that can be readily performed by one with ordinary skill in the art. These electrochemical devices containing the electrolyte solutions as disclosed in the present disclosure and can enable high voltage rechargeable chemistries that would be otherwise difficult with the current electrolyte technologies.

Having described the present disclosure, the following examples are given to illustrate specific applications including the best mode now known to perform the disclosure. They are intended to provide those of ordinary skills in the art with a complete disclosure and description of how to make and use the solvents and additives of the present disclosure. These specific examples are not intended to limit the scope of the disclosure described in this application.

### EXAMPLES

### Example 1

### Synthesis of Tris(1,1,1,3,3,3-hexafluor-iso-propyl)aluminate (Compound 13 in Table 2)

To a flask containing excess amounts of hexafluoroisopropanol, 3.97 g of solid lithium hydride is added through a solid-addition funnel and allowed to react at room temperature. The reaction mixture is stirred at room temperature for 24 hours. Then, 22.22 g of aluminum trichloride is carefully added using a powder solid addition funnel. This reaction is allowed to stir for a minimum of 48 hours to ensure complete reaction and to avoid the production of hydrochloric acid produced from unreacted aluminum trichloride. The final product, tris(1,1,1,3,3,3-hexafluoroisopropyl)aluminate, is recovered by sublimation from the crude product and double sublimated for high purity.

### Example 2

### Synthesis of Tris(perfluoro-t-buty)aluminate (compound 14 in Table 2)

To a flask containing excess amounts of perfluoro-t-butanol, 3.97 g of solid lithium hydride is added through a solid-addition funnel and allowed to react at room temperature. The reaction mixture is chilled by a cold water bath and allowed to stir for 24 hours. Then, 22.22 g of aluminum trichloride is carefully added using a powder solid addition funnel. This reaction is allowed to stir for 72 hours, still chilled by the cold water bath, to ensure complete reaction and to avoid the production of hydrochloric acid produced from unreacted aluminum trichloride. The final product, tris(perfluoro-t-butyl)aluminate, is recovered by sublimation from the crude product and double sublimated for high purity.

### Example 3

### Synthesis of tetrakis(perfluoro-t-butyl)silicate (compound 18 in Table 2)

To a flask containing 500 mL of toluene, 94.41 g ofperfluoro-t-butanol is added and stirred until a complete solution is made. Then 3.176 g lithium hydride is gradually added through a solid addition funnel. After 1 hour, the reaction mixture is chilled to the range of 0-5° C. by immersion in a water/ice bath. Once chilled, 16.98 g of silicon tetrachloride is carefully added with vehement stirring. The purification process was similar to what described in Example 1. The product is a colorless, crystalline powder.

### Example 4

### Formulation of Electrolyte Solutions

This example summarizes a general procedure for the preparation of electrolyte solutions comprising the solvents, solutes and additives of the present disclosure, whose structures have been listed in Table 1. Both the concentration of the lithium salts, the co-solvent ratios, and the relative ratios between the additives to solvents can be varied according to needs.

The salts selected include, but are not limited to, LiPF₆, LiAsF₆, LiBF₄, LiP(CₙF₂ₙ₊₁)ₓF₆₋ₓ(0≦n≦10, 0≦x≦6), LiB(CₙF₂ₙ₊₁)ₓF₄₋ₓ(0≦n≦10, 0≦x≦4), LiIm, LiBeti, LiBOB, and LiBF₂C₂O₄, triethylmethylammonium (Et₃MeNPF₆), any one or more of the compounds whose structures were listed in Table 1, and mixtures thereof.

The solvents selected include, but are not limited to, EC, PC, DMC, DEC, EMC, FEC, CF₃-EC, any one or more of the novel compounds whose structures were listed in Table 1, and mixtures thereof.

In an example, the additives selected include any one or more of the compounds whose structures were listed in Table 1 or Table 2, and mixtures thereof. The resultant electrolyte solution should contain at least one of those compounds that are disclosed in the present disclosure.

In a further example, 1000 g base electrolyte solution of 1.2M LiPF₆/EC/EMC (30:70) was made in the glovebox by mixing 300 g EC and 700 g EMC followed by adding 182.28 g LiPF₆. The aliquots of the base electrolyte solution was then taken to be mixed with various amount of tris(1,1,1,3,3,3-hexafluoroisopropyl)aluminate as synthesized in Example 1. The concentration of tris(1,1,1,3,3,3-hexafluoroisopropyl)aluminate can range from 0.1 ppm up to 5%.

In a similar instance, 1000 g base electrolyte solution of 1.2M LiPF₆/FEC/EC/EMC (15:15:70) was made in glovebox by mixing 150 g FEC, 150 g EC and 700 g EMC followed by adding 182.28 g LiPF₆, and aliquots of the base electrolyte solution was then taken to be mixed with various amount of tris(1,1,1,3,3,3-hexafluoroisopropyl)aluminate as synthesized in Example 1. The concentration of tris(1,1,1,3,3,3-hexafluoroisopropyl)aluminate ranges from 0.1 ppm up to 5%.

In other similar instances, the electrolyte solutions with other compounds at varying concentrations were also made with tris(perfluoro-t-butyl)aluminate (compound 14 in Table 2), or tris(trifluoroethyl)cyclotrioxoaluminin (compound 16 in Table 2), or tris(cyano)bismate.

Table 3 lists some example electrolyte solutions prepared and tested. It should be noted that the compositions disclosed in Table 3 may or may not be the optimum compositions for the electrochemical devices in which they are intended to be used, and they are not intended to limit the scope of the present invention.

TABLE 3
Novel Electrolyte Solutions with Ionic Additives

| Salt | | | | Additive |
|---|---|---|---|---|
| Concentration | | | | Concentration |
| (M) | | Solvent Ratio (by Weight) | | (by Weight) |
| LiPF₆ | (1.2) | EC/FEC/EMC | (15:15:70) | 0.6% Compound 9 |
| LiPF₆ | (1.2) | EC/EMC | (30:70) | 0.3% Compound 11 |
| LiPF₆ | (1.0) | EC/EMC | (30:70) | 1% Compound 16 |
| LiPF₆ | (1.0) | EC/EMC | (30:70) | 1% Compound 19 |
| LiBF₄ | (1.0) | EC/EMC | (30:70) | 0.5% Compound 18 |
| LiBOB | (1.0) | EC/γBL/EMC/MB | (15:15:30:30) | 5% Compound 10 |
| Et₃MeNPF₆ | (2.0) | EC/EMC | (30:70) | 0.3% Compound 16 |

### Example 5

### Fabrication of an Electrochemical Cell

This example discloses a general procedure of an assembly of an example electrochemical cell. These electrochemical cells include Li ion cells, double layer capacitors, or dual intercalation cells. In certain examples, a piece of CELGARD polypropylene separator was sandwiched between an anode and a cathode. The cell was then activated by soaking the separator with the electrolyte solutions as prepared in Example 4, and sealed with appropriate means. All above procedures were conducted under dry atmospheres in either glovebox or dryroom.

With the present disclosure having been described in general and in details and the reference to specific embodiments thereof, it will be apparent to one ordinarily skilled in the art that various changes, alterations, and modifications can be made without departing from the spirit and scope of the present disclosure and its equivalents as defined by the appended claims.

What is claimed is:

1. An electrochemical cell comprising:
a negative electrode;
a positive electrode;
an electrolyte material adapted to allow for ion passivation between the negative and positive electrodes; and
an additive dispersed in the electrolyte material;
wherein the additive includes a compound having at least one fluoro-alkyl functional group and a backbone structure selected from the group consisting of organoaluminum, organosilicon, and organobismuth.

2. The electrochemical cell of claim 1 further comprising a Lithium ion source for Lithium ion passivation between the negative and positive electrodes.

3. The electrochemical cell of claim 1 wherein the additive includes at least one compound having a structure selected from the group (1)-(10) below: 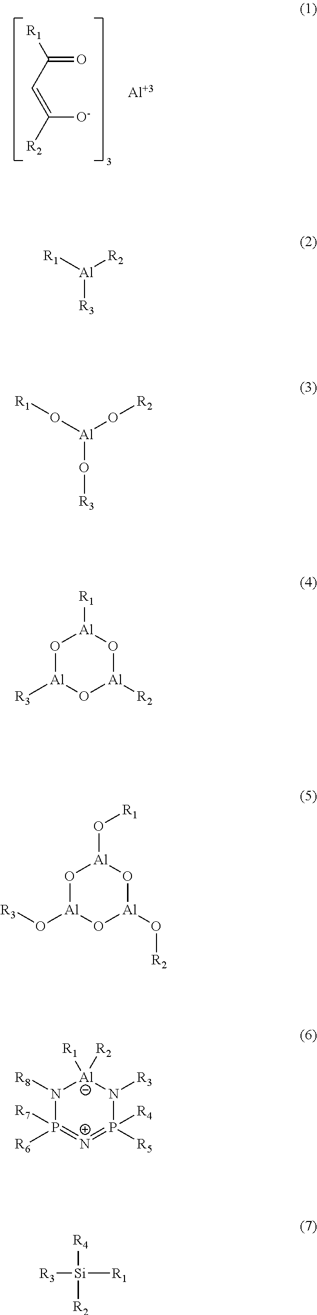 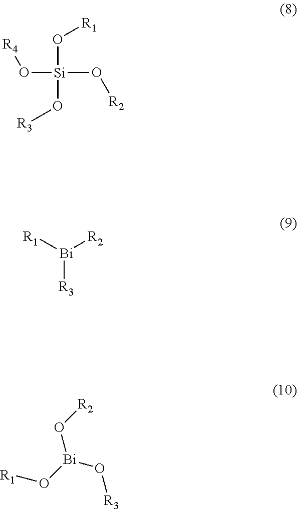
wherein:
R₁, R₂, R₃, R₄, R₅, R₆, R₇, and R₈ designate substituents which are identical or different from each other and selected from the groups (i)-(iv) below:
(i) hydrogen, hydroxyl, or halogen;
(ii) hydroxide salts with metal ions of various valences including at least one of Li⁺, Na⁺, ½Mg²⁺, ⅓Al³⁺, and combinations thereof;
(iii) normal or branched alkyls with carbon number from 1 through 30, with or without unsaturation;
(iv) normal or branched halogenated alkyls with carbon number ranges from 1 to 30, with or without unsaturation, wherein their halogenation degree varies from monohalogenation to perhalogenation; and
(iv) partially halogenated or perhalogenated normal or branched alkyls with a carbon number from 1 through 30, where the halogen substituents are identical or different and selected from the group of F, Cl, Br, I, and mixtures thereof.

4. The electrochemical cell of claim 3 wherein the additive includes at least one compound having a structure selected from the group (11)-(21) below:

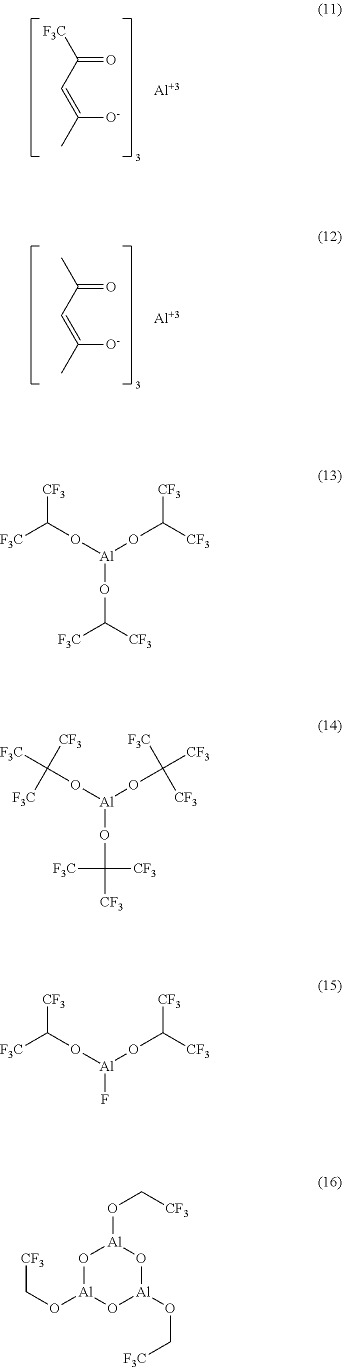

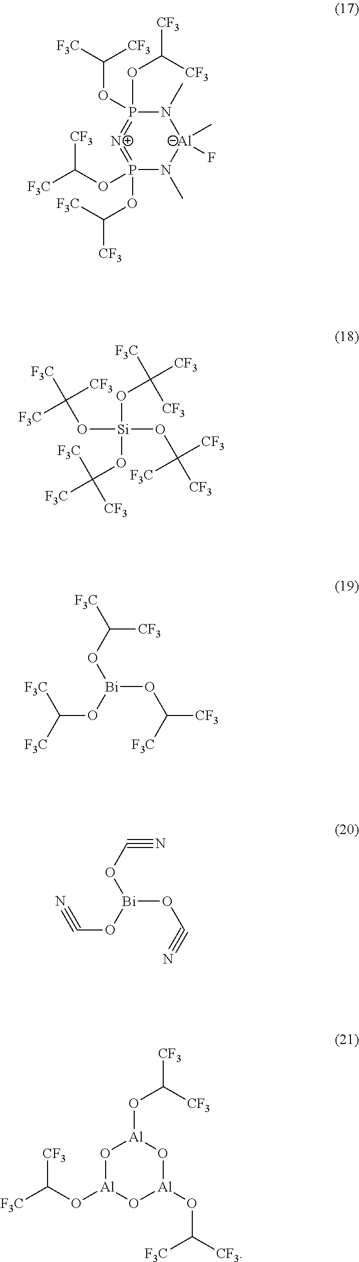

5. The electrochemical cell of claim 3 wherein the electrolyte material comprises a co-solvent, solute or additive including one or more compounds having the structure from the group (1)-(10), further having solubility of at least 1 ppm in a nonaqueous electrolyte solvent.

6. The electrochemical cell of claim 1 wherein the electrolyte material further comprises a non-aqueous organic solvent present in liquid form in the absence of an electric charge.

7. The electrochemical cell of claim 1 further comprising a separator miscible in the electrolyte material, wherein the separator is selected from the group consisting of a porous polyolefin separator and a gellable polymer film.

8. The electrochemical cell of claim 7 wherein the separator is miscible with non-aqueous electrolytes with a solubility of at least 1.0 ppm.

9. The electrochemical cell of claim 1 wherein the electrolyte material includes members from the group consisting of: aqueous solvents, non-aqueous solvents, alkali salts, ammonium salts, phosphonium salts, and mixtures thereof.

10. The electrochemical cell of claim 1 wherein the additive is provided in sufficient amount to passivate the cathode surface and reduce decomposition occurring greater than 4.2 V vs. Li.

11. The electrochemical cell of claim 1 wherein the additive is provided in sufficient amount to passivate the cathode surface and reduce decomposition occurring at voltages of greater than 5.0 V vs. Li.

12. The electrochemical cell of claim 1 wherein the electrolyte material includes an electrolyte composition comprising one or more of: aqueous or non-aqueous solvents, alkali, ammonium, phosphonium or other metal salts, and molecular or ionic additives.

13. The electrochemical cell of claim 1 wherein the electrolyte material includes non-aqueous solvents or solvent mixtures comprising at least one of:
cyclic or acyclic carbonates and carboxylic esters selected from the group consisting: EC, PC, VC, DMC, DEC, EMC, FEC, γ-butyrolactone, methyl butyrate, ethyl butyrate, and mixtures thereof;
cyclic or acyclic ethers selected from diethylether, dimethyl ethoxglycol, tetrahydrofuran, and mixtures thereof;
cyclic or acyclic organic sulfones and sulfites selected from tetramethylene sulfone, ethylene sulfite, ethylmethyl sulfone, and mixtures thereof; and
cyclic or acyclic nitriles selected from acetonitrile, ethoxypropionitrile; and derivatives and mixtures thereof.

14. The electrochemical cell of claim 1 wherein the electrolyte material comprises salt or salt mixture selected from the group consisting of: lithium hexafluorophosphate (LiPF₆), lithium hexafluoroarsenate (LiAsF₆), lithium tetrafluoroborate (LiBF₄), lithium perfluoroalkylfluorophosphate (LiP(CnF₂ₙ₊₁)ₓF₆₋ₓ, where 0≦n≦10, 0≦x≦6), lithium perfluoroalkylfluoroborate (LiB(CnF₂ₙ₊₁)ₓF₄₋ₓ, where 0≦n≦10, 0≦x≦4), lithium bis(trifluoromethanesulfonyl)imide (LiIm), lithium bis(perfluoroethanesulfonyl)imide (LiBeti), lithium bis(oxalato)borate (LiBOB), and lithium (difuorooxalato)borate (LiBF₂C₂O₄), and mixtures thereof.

15. The electrochemical cell of claim 1 wherein the additive is present in a concentration range from 0.1 ppm to 10% with respect to the total solvent weight.

16. The electrochemical cell of claim 1 wherein the additive is present in a concentration range from 0.1% to 1% compared to total volume of the electrolyte material.

17. The electrochemical cell of claim 1 wherein the negative electrode comprises an intercalation material having a lattice structure to accommodate any guest ions or molecules, and wherein the intercalation material is selected from the group consisting of carbonaceous materials with various degree of graphitization, lithiated metal oxides, chalcogenides, and mixtures thereof.

18. The electrochemical cell of claim 1 wherein the positive electrode comprises an active material selected from the group consisting of transition metal oxides, metalphosphates, chalcogenides, carbonaceous materials with various degree of graphitization, and mixtures thereof.

19. The electrochemical cell of claim 1 wherein the positive and negative electrodes comprise materials of either high surface area for double-layer capacitance, or high pseudo-capacitance, or mixture of both.

20. An electrolyte for use in an electrochemical cell having a positive and negative electrode, the electrolyte comprising:
an electrolyte material; and
an additive dispersed in the electrolyte material, wherein the additive includes a compound having at least one fluoro-alkyl functional group and a backbone structure selected from the group consisting of organoaluminum, organosilicon, and organobismuth.
